(19) United States
(12) Patent Application Publication
(10) Pub. No.: US 2023/0050674 A1
(43) Pub. Date: Feb. 16, 2023

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideo TAKAHASHI, Mie (JP); Shinichi TAKASE, Mie (JP); Hiroki SHIMODA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 17/767,762

(22) PCT Filed: Sep. 4, 2020
(86) PCT No.: PCT/JP2020/033543

§ 371 Date: Apr. 8, 2022

(30) Foreign Application Priority Data
Oct. 29, 2019 (JP) 2019-196404

(51) Int. Cl. H01M 50/519; H01M 50/507; H01M 50/569; H01M 10/48

(52) U.S. Cl. CPC H01M 50/519; H01M 50/507; H01M 50/569; H01M 10/482; H01M 2220/20

(57) ABSTRACT

A wiring module to be attached to a plurality of power storage devices arranged in an arrangement direction, the wiring module including: an insulating protector; and a flexible printed wiring board disposed in the protector, wherein the protector has a shape extending in the arrangement direction, the flexible printed wiring board includes a main body part extending in the arrangement direction and disposed in the protector, and an extension piece extending from the main body part, the extension piece has a curved portion that is curved, and the extension piece is inverted by the curved portion, and the protector includes a locking part that locks to the extension piece from a direction to prevent the curved portion from deforming back to an original shape thereof.

### TECHNICAL FIELD

The present disclosure relates to a wiring module.

### BACKGROUND ART

As a conventional wiring module to be attached to a plurality of power storage devices each including a positive electrode and a negative electrode, the wiring module described in Patent Document 1 is known. The wiring module includes a flexible printed wiring board including an insulating sheet, and a plurality of voltage detection lines formed on the sheet. The plurality of voltage detection lines are configured to detect the voltages of the plurality of power storage devices. The flexible printed wiring board is folded over itself by being bent along a boundary line formed on the flexible printed wiring board.

### CITATION LIST

### Patent Document

Patent Document 1: JP 2011-49158

### SUMMARY OF INVENTION

### Technical Problem

However, with the above-described technique, the flexible printed wiring board is bent along the boundary line so as to form a shape having a sharply pointed corner portion. Accordingly, there is concern that an excessively large force will be applied to the flexible printed wiring board. This in turn causes concern that problems such as damage to the sheet, and breakage of the voltage detection lines may occur.

The present disclosure has been completed in view of the above-described circumstances, and it is an object of the present disclosure to provide a wiring module configured to prevent an excessively large force from being applied to a flexible printed wiring board.

### Solution to Problem

The present disclosure is directed to a wiring module to be attached to a plurality of power storage devices arranged in an arrangement direction, the wiring module including: an insulating protector; and a flexible printed wiring board disposed in the protector, wherein the protector has a shape extending in the arrangement direction, the flexible printed wiring board includes a main body part extending in the arrangement direction and disposed in the protector, and an extension piece extending from the main body part, the extension piece has a curved portion that is curved, and the extension piece is inverted by the curved portion, and the protector includes a locking part that locks to the extension piece from a direction to prevent the curved portion from deforming back to an original shape thereof.

### Advantageous Effects of Invention

According to the present disclosure, it is possible to prevent an excessively large force from being applied to a flexible printed wiring board.

### BRIEF DESCRIPTION OF DRAWINGS

FIG. 1 is a partially enlarged plan view showing a power storage module according to Embodiment 1.

FIG. 2 is a partially enlarged perspective view showing a wiring module according to Embodiment 1.

FIG. 3 is a cross-sectional view taken along the line III-III in FIG. 1.

FIG. 4 is a cross-sectional view taken along the line IV-IV in FIG. 1.

FIG. 5 is a cross-sectional view taken along the line V-V in FIG. 1.

FIG. 6 is a cross-sectional view taken along the line VI-VI in FIG. 1.

FIG. 7 is a cross-sectional view taken along the line VII-VII in FIG. 1.

FIG. 8 is a schematic diagram showing a vehicle in which the power storage module according to Embodiment 1 is mounted.

FIG. 9 is a partially enlarged cross-sectional view showing a locking structure of an extension piece in a wiring module according to Embodiment 2.

FIG. 10 is a partially enlarged plan view showing the locking structure of the extension piece in the wiring module according to Embodiment 2.

FIG. 11 is a partially enlarged cross-sectional view showing a locking structure of an extension piece in a wiring module according to Embodiment 3.

FIG. 12 is a partially enlarged plan view showing the locking structure of the extension piece in the wiring module according to Embodiment 3.

FIG. 13 is a partially enlarged cross-sectional view showing a locking structure of an extension piece in a wiring module according to Embodiment 4.

FIG. 14 is a partially enlarged plan view showing the locking structure of the extension piece in the wiring module according to Embodiment 4.

### DESCRIPTION OF EMBODIMENTS

### Description of Embodiments of the Present Disclosure

First, aspects of the present disclosure will be enumerated and described below.

(1) The present disclosure is directed to a wiring module to be attached to a plurality of power storage devices arranged in an arrangement direction, the wiring module including: an insulating protector; and a flexible printed wiring board disposed in the protector, wherein the protector has a shape extending in the arrangement direction, the flexible printed wiring board includes a main body part extending in the arrangement direction and disposed in the protector, and an extension piece extending from the main body part, the extension piece has a curved portion that is curved, and the extension piece is inverted by the curved portion, and the protector includes a locking part that locks to the extension piece from a direction to prevent the curved portion from deforming back to an original shape thereof.

When the direction in which the side extension piece is routed is changed by inverting the extension piece, distortion occurs in the extension piece. According to the present disclosure, this distortion can be dispersed by the curved portion. Accordingly, it is possible to prevent an excessively large force from being applied to the flexible printed wiring board.

Furthermore, as a result of the locking part locking to the extension piece, it is possible to prevent the curved portion of the extension piece from deforming back to its original shape. Accordingly, it is possible to keep the curved state of the curved portion.

(2) It is preferable that the protector includes a placement part on which the main body part is disposed, the locking part protrudes, from a distal end of a column part protruding from the placement part, in a direction intersecting a direction in which the column part extends, and the locking part locks to the extension piece from a side opposite to the placement part.

With a simple operation of disposing the extension piece between the placement part and the locking part, it is possible to hold the extension piece in the protector, while keeping the curved state of the curved portion of the extension piece. This can improve the manufacturing efficiency of the wiring module.

(3) It is preferable that an interval between the locking part and the placement part is set to be larger than the thickness of the extension piece.

Since the interval between the locking part and the placement part is larger than the thickness of the extension piece, the operation of locking the extension piece to the locking part is made easier.

(4) It is preferable that the extension piece and the main body part are coupled to each other via a proximal end portion, and the main body part includes a cut-out portion extending from the proximal end portion in the arrangement direction, and from which the extension piece is cut out.

The extension piece can be formed by cutting out an extension piece from the main body part along the arrangement direction in which the power storage devices are arranged, and curving the extension piece. As a result, it is possible to increase the yield of the flexible printed wiring board as compared with the case where the extension piece is are formed so as to extend laterally from a side edge of the main body part.

(5) It is preferable that the extension piece extends outward relative to a contour of the main body part.

The extension piece can be routed in a region located outward relative to the contour of the main body part.

(6) It is preferable that a detection unit that detects the state of at least one of the plurality of power storage devices is connected to a distal end portion of the extension piece, and the distal end portion of the extension piece is pressed against the at least one of the plurality of power storage devices.

The state of the power storage device can be detected by the detection unit connected to the distal end portion of the extension piece.

(7) It is preferable that the flexible printed wiring board has a first surface on which a conductive path is formed, and a second surface on which the conductive path is not formed, and the detection unit is connected to the conductive path on the first surface of the extension piece.

It is possible to reduce the manufacturing cost of the flexible printed wiring board as compared with the case where the conductive path is formed on both surfaces of the flexible printed wiring board.

(8) It is preferable that the second surface of the distal end portion of the extension piece is pressed against the power storage device.

Since the second surface, on which the conductive path is not formed, of the flexible printed wiring board is pressed against the power storage device, it is possible to prevent an excessive force from being applied to the conductive path. This can suppress the occurrence of a problem in the conductive path.

(9) It is preferable that the wiring module is a vehicle wiring module that is to be used mounted in a vehicle.

Since the vibrations of the vehicle are absorbed by the curved portion, it is possible to suppress the occurrence of a problem in the flexible printed wiring board.

### Details of Embodiments of the Present Disclosure

Hereinafter, embodiments of the present disclosure will be described. It should be noted that the present disclosure is not limited to these examples, but is defined by the claims, and is intended to include all modifications which fall within the scope of the claims and the meaning and scope of equivalents thereof.

### Embodiment 1

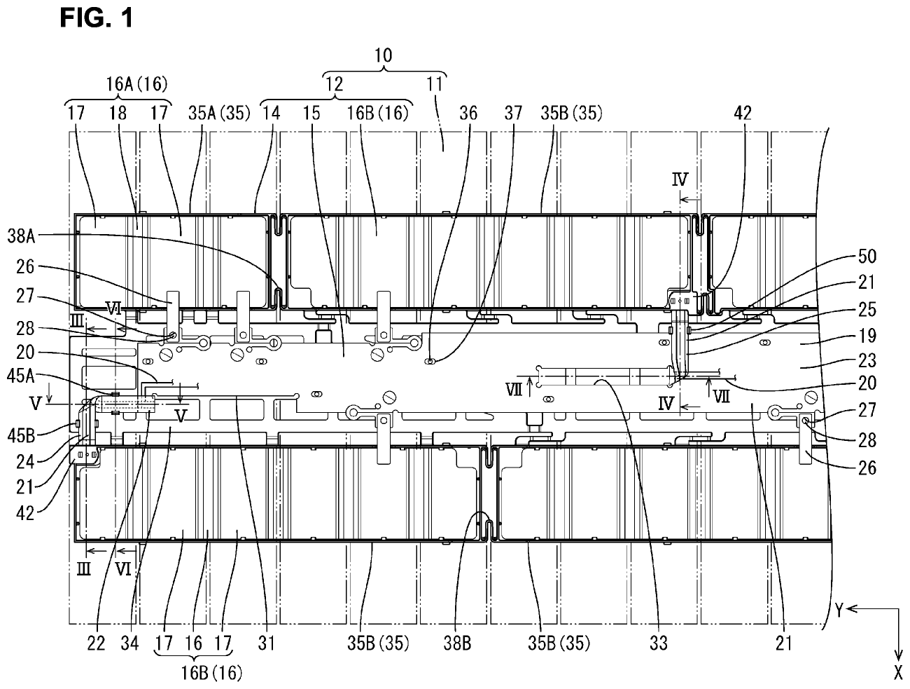

Embodiment 1, in which the present disclosure is applied to a power storage pack 2 that is mounted in a vehicle 1, will be described with reference to FIGS. 1 to 8. The power storage pack 2 is mounted in a vehicle 1 such as an electric automobile or a hybrid automobile, and is used as a driving source of the vehicle 1.

### Overall Configuration

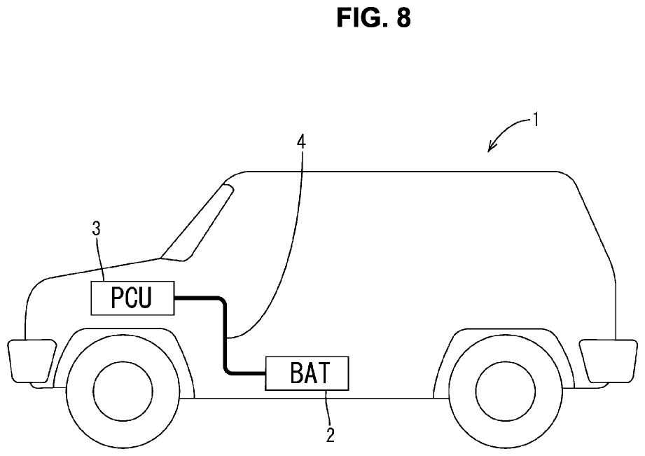

As shown in FIG. 8, the power storage pack 2 is disposed in the vicinity of the center of the vehicle 1. A PCU 3 (Power Control Unit) is disposed in a front portion of the vehicle 1. The power storage pack 2 and the PCU 3 are connected to each other by a wire harness 4. The power storage pack 2 and the wire harness 4 are connected to each other by a connector, which is not shown. The power storage pack 2 includes a power storage module 10 including a plurality of power storage devices 11.

As shown in FIG. 1, the power storage module 10 includes a plurality of power storage devices 11, and a wiring module 12 attached to the plurality of power storage devices 11. The following description will be given assuming that the direction indicated by the arrow Z is the upward direction, the direction indicated by the arrow Y is the forward direction, and the direction indicated by the arrow X is the leftward direction. For a plurality of identical members, reference numerals may be assigned to some of the members, and reference numerals may be omitted for the other members.

### Power Storage Device 11

As shown in FIG. 1, the plurality of power storage devices 11 are arranged along the front-rear direction (an example of the arrangement direction). Each power storage device 11 has a flat, substantially rectangular parallelepiped shape, and a power storage element (not shown) is accommodated thereinside. A pair of electrode terminals 13 protrude upward from an upper surface of the power storage device 11. One of the two electrode terminals 13 is a positive electrode, and the other is a negative electrode.

### Wiring Module 12

As shown in FIG. 1, a wiring module 12 having a shape elongated in the front-rear direction is disposed on the upper surface of the plurality of power storage devices 11.

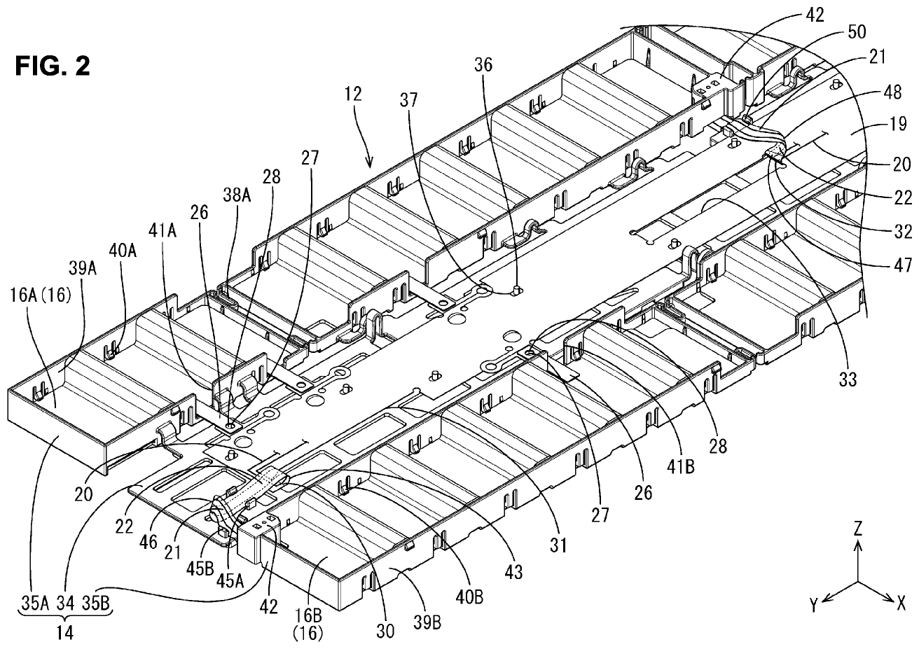

As shown in FIG. 2, the wiring module 12 includes a protector 14, and a flexible printed wiring board 15 held in the protector 14. Additionally, a plurality of bus bars 16 connected to the electrode terminals 13 of the power storage devices 11 are accommodated in the protector 14.

### Bus Bars 16

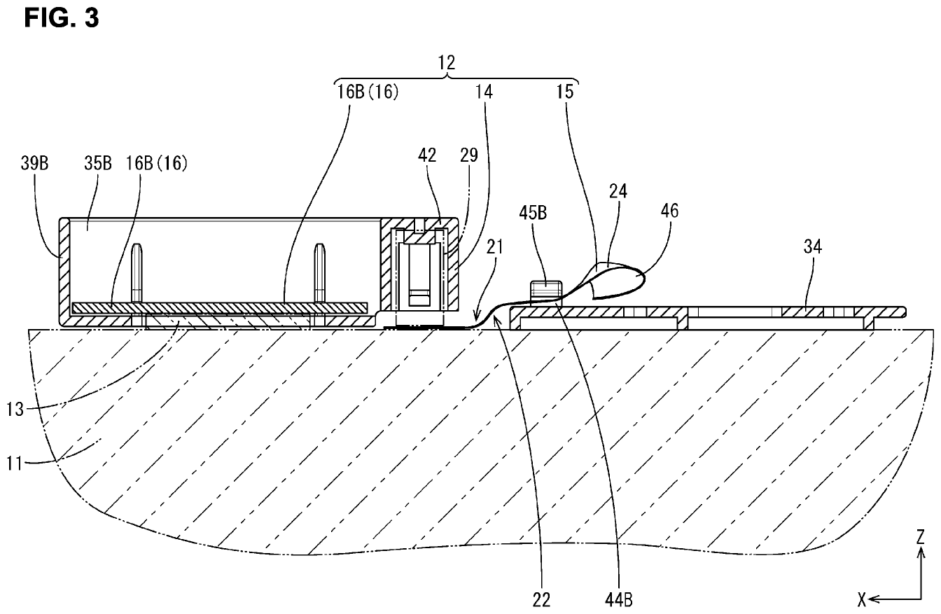

As shown in FIG. 3, the bus bars 16 are connected to the electrode terminals 13 of the power storage devices 11. Each bus bar 16 is formed by pressing a metal plate made of copper, a copper alloy, aluminum, an aluminum alloy, or the like. A plated layer, which is not shown, may be formed on the surface of the bus bar 16. Any metal such as tin or nickel can be selected as the metal for forming the plated layer. The bus bar 16 includes a plurality of terminal connection parts 17 electrically connected to the electrode terminals 13, and a coupling part 18 that couples the adjacent terminal connection parts 17 to each other.

Each terminal connection part 17 has a substantially rectangular shape that is elongated in the left-right direction, as viewed from above. As viewed from above, the contour of the terminal connection part 17 is formed to be larger than the contour of the electrode terminal 13. The method for connecting the terminal connection part 17 and the electrode terminal 13 is not particularly limited, and it is possible to select any method, including, for example, soldering, brazing, ultrasonic welding, and laser welding. In the present embodiment, the terminal connection part 17 and the electrode terminal 13 are laser-welded.

As shown in FIG. 2, each coupling part 18 protrudes upward in a crest-like shape, as viewed from the side. The coupling part 18 is configured to be deformable in the front-rear direction. This makes it possible to adjust the interval in the front-rear direction between the terminal connection parts 17 coupled to each other via the coupling part 18 in the front-rear direction.

As shown in FIG. 1, the bus bars 16 include two types of bus bars 16, namely small bus bars 16A each including three coupling parts 18, and large bus bars 16B each including six coupling parts 18. In the following description, when there is no need to distinguish between the small bus bar 16A and the large bus bar 16B, they are referred to as the bus bar 16.

The three terminal connection parts 17 of each small bus bar 16A are connected to the electrode terminals 13 of the respective corresponding three power storage devices 11. The three electrode terminals 13 connected to the small bus bar 16A have the same polarity. Accordingly, the three power storage devices 11 are connected in parallel via the small bus bar 16A.

The six terminal connection parts 17 of each large bus bar 16B are connected to the electrode terminals 13 of the respective corresponding six power storage devices 11. The three electrode terminals 13 connected to the front three terminal connection parts 17 of the six terminal connection parts 17 of the large bus bar 16B have the same polarity. On the other hand, three electrode terminals 13 having a polarity different from that of the three electrode terminals 13 connected to the front three terminal connection parts 17 are connected to the rear three terminal connection parts 178 of the six terminal connection portions 17. Accordingly, two sets of power storage devices 11, each set including three power storage devices 11 connected in parallel, are formed, and these sets of power storage devices 11 connected in parallel are to be connected in series.

### Flexible Printed Wiring Board 15

As shown in FIG. 2, the flexible printed wiring board 15 includes an insulating sheet 19 formed of a polyimide film, a liquid crystalline film, or the like, and a conductive path 20 formed on the sheet 19 using a printed wiring technique. In the present embodiment, the sheet 19 has a first surface 21 on which a plurality of conductive paths 20 are formed, and a second surface 22 on which the conductive paths 20 are not formed. Note that the first surface 21 and the second surface 22 of the sheet 19 may be covered by an insulating cover layer (not shown). Some of the conductive paths 20 on the flexible printed wiring board 14 are illustrated, and illustrations of the other conductive paths 20 have been omitted.

The flexible printed wiring board 15 includes a main body part 23 having a rectangular shape elongated substantially in the front-rear direction, and a side extension piece 24 (an example of the extension piece) and a center extension piece 25 (an example of the extension piece) that extend outward from the contour of the main body part 23. The flexible printed wiring board 15 is electrically connected to an ECU (Electronic Control Unit), which is not shown.

As shown in FIGS. 1 and 2, a plurality of coupling pieces 26 that are to be connected to the corresponding bus bars 16 are connected to each of the right edge and the left edge of the main body part 23. Each coupling piece 26 is formed by pressing a conductive metal plate into a predetermined shape. As the metal for forming the coupling piece 26, it is possible to select any metal such as copper, a copper alloy, aluminum, an aluminum alloy, nickel, and a nickel alloy.

The coupling piece 26 has a rectangular shape elongated in the left-right direction, as viewed from above. A through hole 27 is formed in a portion of the coupling piece 26 that is placed on the main body part 23. The coupling piece 26 and the conductive path 20 formed in the main body part 23 are electrically connected to each other via solder 28 filled into the through hole 27. The solder 28 is injected into the through hole 27 in a molten state into the through hole 27 and then solidified, thus filling the through hole 27.

A portion of the coupling piece 26 that is placed on the bus bar 16 is electrically connected to the bus bar 16 by any method, including, for example, soldering, brazing, ultrasonic welding, and laser welding. In the present embodiment, the coupling piece 26 and the bus bar 16 are laser-welded. Accordingly, the bus bar 16 and the conductive path 20 are electrically connected to each other via the coupling piece 26. The voltage across the electrode terminals 13 of each power storage device 11 is detected by the ECU via the bus bar 16, the coupling piece 26, and the conductive path 20.

### Side Extension Piece 24

As shown in FIG. 1, at a position toward a front end portion of the left edge of the flexible printed wiring board 15, a side extension piece 24 extends forward relative to the front edge of the main body part 23. A routing path of the side extension piece 24 extends forward of the main body part 23, and thereafter changes to the left side. As shown in FIG. 3, a thermistor unit 29 (an example of the detection unit) including a thermistor (not shown) is connected to a distal end portion of the side extension piece 24. The thermistor is electrically connected to the conductive path 20 formed on the first surface 21 of the side extension piece 24.

The side extension piece 24 is formed in an elongated band shape. The side extension piece 24 is formed by making a cut-out of a predetermined length in the left edge of the main body part 23. The side extension piece 24 and the main body part 23 are coupled to each other via a first proximal end portion 30 (an example of the proximal end portion). A first cut-out portion 31 (an example of the cut-out portion) from which the side extension piece 24 is cut out is formed in the main body part 23 so as to extend rearward from the first proximal end portion 30. The first cut-out portion 31 is formed at a position toward the front end portion of the left edge of the main body part 23 so as to be recessed rightward.

### Center Extension Piece 25

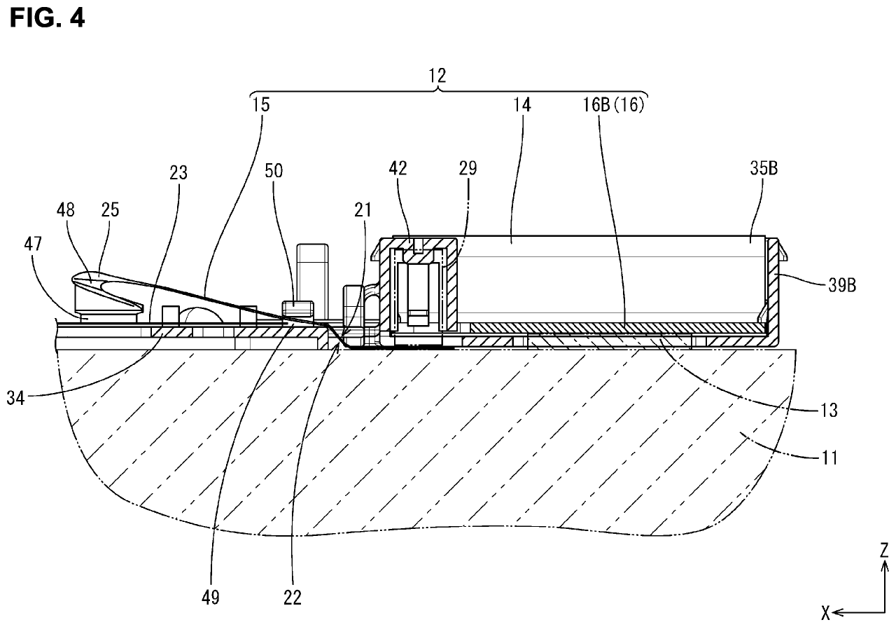

As shown in FIG. 1, a center extension piece 25 extending rightward from the vicinity of the center of the main body part 23 in the left-right direction is formed on the flexible printed wiring board 15. The center extension piece 25 extends rightward relative to the right edge of the main body part 23. As shown in FIG. 4, a thermistor unit 29 (an example of the detection unit) including a thermistor (not shown) is connected to a distal end portion of the center extension piece 25.

The center extension piece 25 is formed in an elongated band shape. The center extension piece 25 is formed by making a cut-out of a predetermined length in the vicinity of the center of the main body part 23 in the left-right direction. The center extension piece 25 and the main body part 23 are coupled to each other via a second proximal end portion 32 (an example of the proximal end portion). A second cut-out portion 33 (an example of the cut-out portion) from which the center extension piece 25 is cut out is formed in the main body part 23 so as to extend forward from the second proximal end portion 32. The second cut-out portion 33 extends through the main body part 23 in the up-down direction in the vicinity of the center of the main body part 23 in the left-right direction.

Each thermistor unit 29 detects the temperature of the corresponding power storage device 11, and transmits a temperature detection signal thereof to the ECU via the conductive path 20. The ECU monitors whether or not the temperature of the power storage device 11 that has been obtained from the thermistor unit 29 is within a predetermined normal value.

### Protector 14

As shown in FIGS. 1 and 2, the protector 14 has a shape elongated in the front-rear direction. The protector 14 is formed by injection molding an insulating synthetic resin. The protector 14 includes a placement part 34 on which the flexible printed wiring board 15 is disposed, and a plurality of bus bar accommodating parts 35 that are formed on the left and right sides of the placement part 34, and in which the bus bars 16 are accommodated.

### Placement Part 34

As shown in FIGS. 1 and 2, the placement part 34 is formed in a plate shape that is elongated in the front-rear direction, and is flat in the up-down direction. The flexible printed wiring board 15 is disposed on the upper surface of the placement part 34. The flexible printed wiring board 15 is disposed on the placement part 34, with the first surface 21 of the main body part 23 facing upward, and the second surface 22 thereof facing downward.

As shown in FIG. 2, an engagement pin 36 protruding upward is formed on the placement part 34 at a portion on which the main body part 23 is placed. The engagement pin 36 is formed in a cylindrical columnar shape. An elongated hole 37 elongated in the front-rear direction is formed in the placement part 34 at a position corresponding to the engagement pin 36. As a result of the engagement pin 36 being passed through the elongated hole 37, the placement part 34 is disposed at a predetermined position of the main body part 23. The engagement pin 36 is movable in the front-rear direction inside the elongated hole 37 elongated in the front-rear direction. Consequently, the main body part 23 elongated in the front-rear direction, and the placement part 34 elongated in the front-rear direction are movable relative to each other in the front-rear direction according to their respective tolerances.

Although not illustrated in detail, an enlarged diameter portion may be formed at a distal end of the engagement pin 36 by pressurizing the distal end under heat. In this case, the enlarged diameter portion engages with a hole edge portion of the elongated hole 37, as a result of which the main body part 23 is held so as to be prevented from being dislodged upward from the placement part 34.

### Bus Bar Accommodating Part 35

As shown in FIGS. 1 and 2, of the bus bar accommodating parts 35 disposed on the right side of the main body part 23, the bus bar accommodating part 35 located at the front end portion serves as a small bus bar accommodating part 35A in which the small bus bar 16A is accommodated. A large bus bar accommodating part 35B in which the large bus bar 16B is accommodated is disposed rearward of the small bus bar accommodating part 35A. The small bus bar accommodating part 35A and the large bus bar accommodating part 35B are connected to each other using a hinge part 38A that undergoes flexural deformation in the front-rear direction. As a result of the hinge part 38A undergoing flexural deformation in the front-rear direction, the small bus bar accommodating part 35A and the large bus bar accommodating part 35B move in the front-rear direction so as to follow the tolerance of the power storage device 11 and dimensional changes in the power storage device 11 due to expansion or contraction in the front-rear direction.

On the left side of the main body part 23, a plurality of large bus bar accommodating parts 35B in each of which a large bus bar 16B is accommodated are arranged in the front-rear direction. The large bus bar accommodating parts 35B arranged in the front-rear direction are connected to each other using a hinge part 38B that undergoes flexural deformation in the front-rear direction. As a result of the hinge part 38B undergoing flexural deformation in the front-rear direction, the large bus bar accommodating parts 35B move in the front-rear direction so as to follow the tolerance of the power storage device 11 and dimensional changes in the power storage device 11 due to expansion or contraction in the front-rear direction.

The small bus bar accommodating part 35A includes a frame part 39A that has a rectangular shape elongated in the front-rear direction as viewed from above, and that is slightly larger than the contour of the small bus bar 16A. Locking pawls 40A extending in the up-down direction are formed on the frame part 39A. The locking pawls 40A are formed to be elastically deformable in the left-right direction. As a result of lower end portions of the locking pawls 40A locking to the small bus bar 16A from above, the small bus bar 16A is held in the small bus bar accommodating part 35A so as to be prevented from being dislodged upward.

A coupling piece insertion part 41A that is open upward is formed in a left side portion of the frame part 39A of the small bus bar accommodating part 35A. The coupling piece 26 described above is inserted from above into the coupling piece insertion part 41A.

Each of the large bus bar accommodating parts 35B includes a frame part 39B that has a rectangular shape elongated in the front-rear direction as viewed from above, and that is slightly larger than the contour of the large bus bar 16B. Locking pawls 40B extending in the up -down direction are formed on the frame part 39B. The locking pawls 40B are formed to be elastically deformable in the left-right direction. As a result of lower end portions of the locking pawls 40B locking to the large bus bar 16B from above, the large bus bar 16B is held in the large bus bar accommodating part 35B so as to be prevented from being dislodged upward.

A coupling piece insertion part 41B that is open upward is formed in a left side portion of the frame part 39B of the large bus bar accommodating part 35B. The coupling piece 26 described above is inserted from above into the coupling piece insertion part 41B.

As shown in FIGS. 1 and 2, a thermistor accommodating part 42 in which the corresponding thermistor unit 29 is accommodated is formed at a front right corner of the large bus bar accommodating part 35B formed at a front end portion of the plurality of large bus bar accommodating parts 35B provided on the left side of the protector 14. The thermistor accommodating part 42 is formed in the shape of a box that is closed at the top and open at the bottom. The inside of the thermistor accommodating part 42 is formed to be larger than the contour of the thermistor unit 29. The thermistor unit 29 is held inside the thermistor accommodating part 42 so as to be movable in the up-down direction.

As shown in FIGS. 1 and 2, a thermistor accommodating part 42 in which the thermistor unit 29 is accommodated is formed at a rear left corner of the large bus bar accommodating part 35B formed on the forwardmost side of the plurality of large bus bar accommodating parts 35B provided on the right side of the protector 14. The structure of the thermistor accommodating part 42 is the same as the one described above, and therefore redundant descriptions have been omitted.

### Routing Structure of Side Extension Piece 24

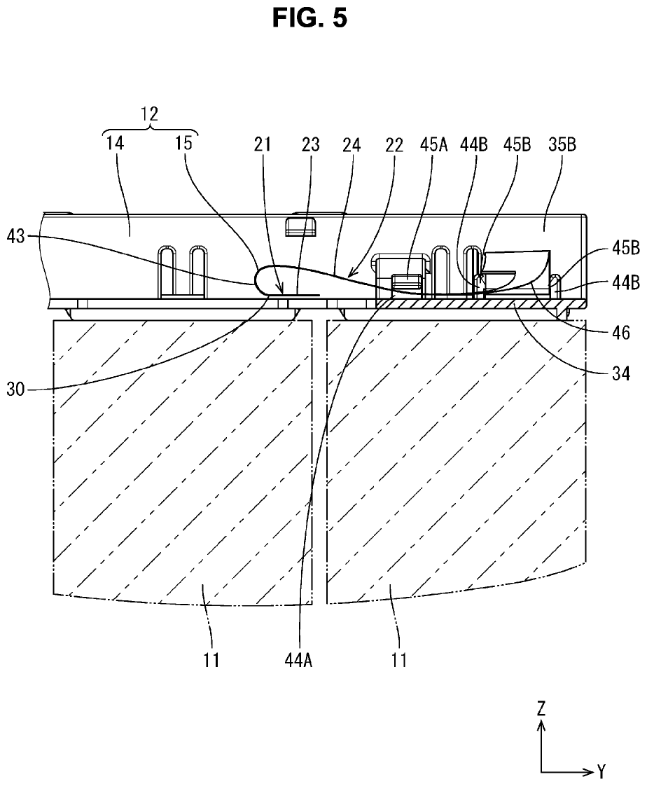

As shown in FIG. 5, the main body part 23 and the side extension piece 24 are coupled to each other via the first proximal end portion 30. A first side curved portion 43 (an example of the curved portion) is formed rearward of the first proximal end portion 30. The first side curved portion 43 is curved such that the first surface 21 is disposed on the inner side, and the second surface 22 is disposed on the outer side. In the first side curved portion 43, the first surface 21 and the second surface 22 are each formed by a curved surface. The side extension piece 24 is routed rearward from the first proximal end portion 30, and thereafter the routing direction thereof is changed to the forward direction by the first side curved portion 43.

The main body part 23 is disposed on the placement part 34, with the first surface 21 facing upward. At a portion of the side extension piece 24 that is located forward relative to the first side curved portion 43, the second surface 22 faces upward. In this manner, the side extension piece 24 is inverted by the first side curved portion 43.

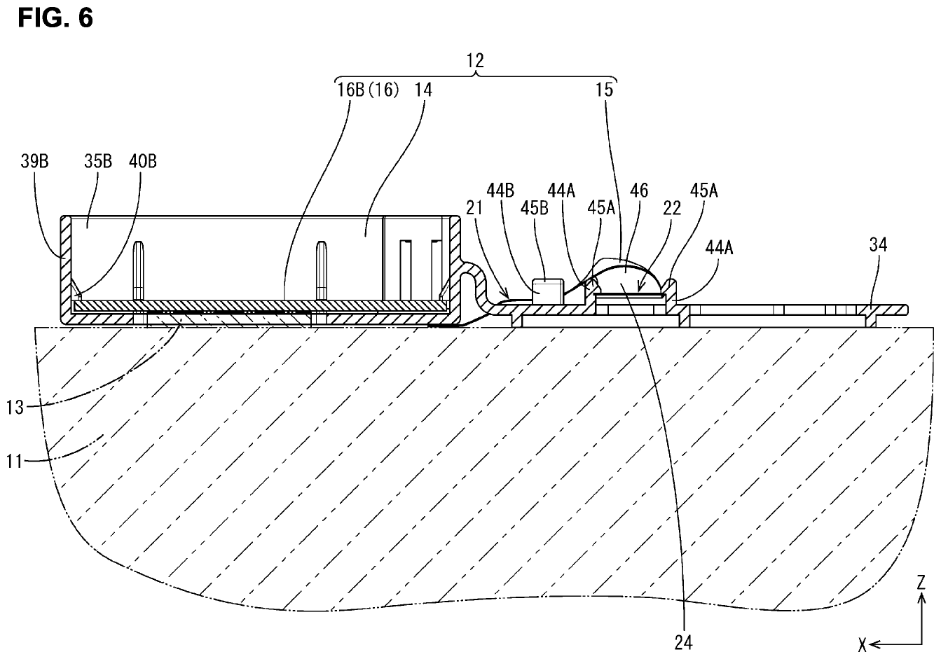

As shown in FIGS. 5 and 6, a pair of column parts 44A protruding upward from the placement part 34 are formed on the left and right sides of the side extension piece 24 at a position located forward relative to the first side curved portion 43. Each column part 44A has a quadrangular cross-sectional shape. A locking part 45A protruding leftward is formed at an upper end portion of the column part 44A provided on the right side of the side extension piece 24, and a locking part 45A protruding rightward is formed at an upper end portion of the column part 44A provided on the left side of the side extension piece 24.

As a result of the locking parts 45A engaging with the side extension piece 24 from above at a position located forward relative to the first side curved portion 43, the side extension piece 24 is held on the placement part 34 in a state in which the first side curved portion 43 is prevented from springing upward so as to deform back to its original shape.

As shown in FIG. 5, the interval between the lower surface of each locking part 45A and the upper surface of the placement part 34 is formed to be larger than the thickness of the side extension piece 24. Accordingly, the side extension piece 24 is flexed in the space between the locking part 45A and the placement part 34. In the present embodiment, a rear end portion of each of the locking parts 45A and the side extension piece 24 are in contact with each other, and a front end portion of each of the locking parts 45A and the side extension piece 24 are separated from each other.

As shown in FIG. 2, the lateral extension portion has a second side curved portion 46 (an example of the curved portion) formed at a position located forward relative to the locking parts 45A described above. The second side curved portion 46 is curved such that the second surface 22 is disposed on the inner side, and the first surface 21 is disposed on the outer side. In the second side curved portion 46, the first surface 21 and the second surface 22 are each formed by a curved surface. A portion of the lateral extension portion that is located forward relative to the locking parts 45A is routed forward, and thereafter the routing direction thereof is changed to the leftward direction by the second side curved portion 46.

As shown in FIG. 2, a portion of the lateral extension portion that extends from the first side curved portion 43 to the second side curved portion 46 is disposed on the placement part 34, with the second surface 22 facing upward. At a portion of the side extension piece 24 that is located leftward relative to the second side curved portion 46, the first surface 21 faces upward. In this manner, the side extension piece 24 is inverted by the second side curved portion 46.

As shown in FIGS. 1 and 2, a pair of column parts 44B protruding upward from the placement part 34 are formed on the front and rear sides of the side extension piece 24 at a position located leftward relative to the second side curved portion 46. Each column part 44B has a quadrangular cross-sectional shape. A locking part 45B protruding forward is formed at an upper end portion of the column part 44B provided on the rear side of the side extension piece 24, and a locking part 45B protruding rearward is formed at an upper end portion of the column part 44B provided on the front side of the side extension piece 24.

As shown in FIG. 3, as a result of the locking parts 45B engaging with the side extension piece 24 from above at a position located leftward relative to the second side curved portion 46, the side extension piece 24 is held on the placement part 34 in a state in which the second side curved portion 46 is prevented from springing upward so as to deform back to its original shape.

As shown in FIG. 3, the interval between the lower surface of each locking part 45B and the upper surface of the placement part 34 is formed to be larger than the thickness of the side extension piece 24. Accordingly, the side extension piece 24 is flexed in the space between the locking part 45B and the placement part 34. In the present embodiment, a right end portion of each of the locking parts 45B and the side extension piece 24 are in contact with each other, and a left end portion of each of the locking parts 45B and the side extension piece 24 are separated from each other.

As shown in FIG. 3, a distal end portion of the side extension piece 24 is disposed below the thermistor accommodating part 42. The thermistor unit 29 is disposed on the first surface 21 side of the side extension piece 24. The thermistor unit 29 is biased downward by a biasing member (not shown) disposed inside the thermistor accommodating part 42. Accordingly, the side extension piece 24 to which the thermistor unit 29 is connected is also biased downward. As a result, the second surface 22 of the side extension piece 24 is pressed against the upper surface of the power storage device 11 from above.

The heat of the power storage device 11 is transferred to the second surface 22 of the side extension piece 24, is then conducted through the side extension piece 24 to the first surface 21, and is then transferred from the first surface 21 of the side extension piece 24 to the thermistor unit 29. The heat is conducted through the thermistor unit 29 to the thermistor, and the temperature is detected.

### Routing Structure of Center Extension Piece 25

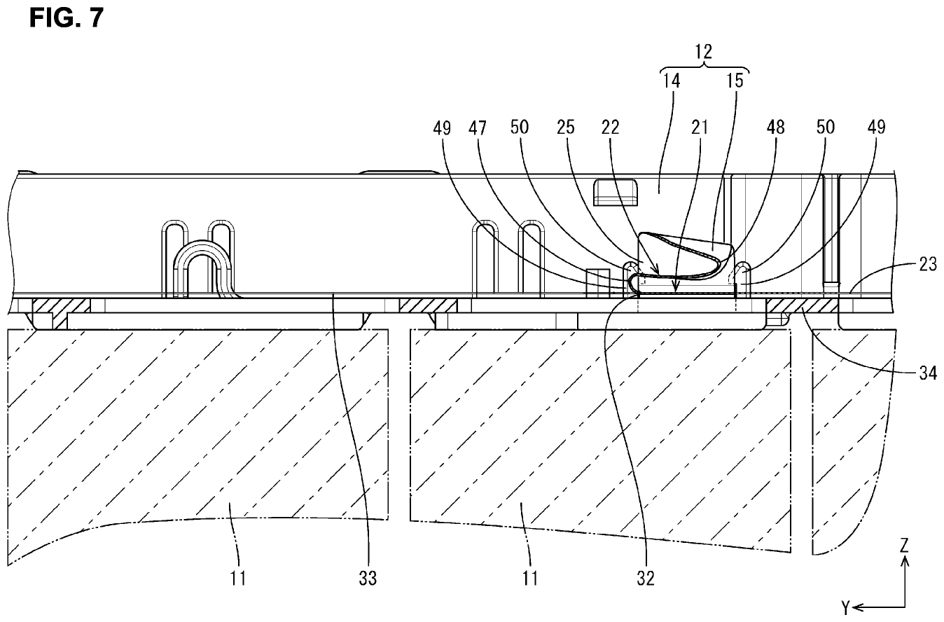

As shown in FIG. 7, the main body part 23 and the center extension piece 25 are coupled to each other via the second proximal end portion 32. A first center curved portion 47 (an example of the curved portion) is formed forward of the second proximal end portion 32. The first center curved portion 47 is curved such that the first surface 21 is disposed on the inner side and the second surface 22 is disposed on the outer side. In the first center curved portion 47, the first surface 21 and the second surface 22 are each formed by a curved surface. The center extension piece 25 is routed forward from the second proximal end portion 32, and thereafter the routing direction thereof is changed to the rearward direction by the first center curved portion 47.

As shown in FIG. 7, the main body part 23 is disposed on the placement part 34, with the first surface 21 facing upward. At a portion of the center extension piece 25 that is located rearward relative to the first center curved portion 47, the second surface 22 faces upward. In this manner, the center extension piece 25 is inverted by the first center curved portion 47.

As shown in FIG. 7, the center extension piece 25 has a second center curved portion 48 (an example of the curved portion) formed at a position located rearward relative to the first center curved portion 47. The second center curved portion 48 is curved such that the second surface 22 is disposed on the inner side, and the first surface 21 is disposed on the outer side. In the second center curved portion 48, the first surface 21 and the second surface 22 are each formed by a curved surface. A portion of the center extension portion that is located rearward relative to the first center curved portion 47 is routed rearward, and thereafter the routing direction thereof is changed to the rightward direction by the second center curved portion 48.

As shown in FIG. 7, a portion of the center extension portion that extends from the first center curved portion 47 to the second side curved portion 46 is disposed on the placement part 34, with the second surface 22 facing upward. At a portion of the center extending piece 25 that is located rightward relative to the second center curved portion 48, the first surface 21 faces upward. In this manner, the center extending piece 25 is inverted by the second center curved portion 48.

As shown in FIGS. 1 and 2, a pair of column parts 49 protruding upward from the placement part 34 are formed on the left and right sides of the center extending piece 25 at a position located rightward relative to the second center curved portion 48. Each column part 49 has a quadrangular cross-sectional shape. A locking part 50 protruding rightward is formed at an upper end portion of the column part 49 provided on the left side of the center extending piece 25, and a locking part 50 protruding leftward is formed at an upper end portion of the column part 49 provided on the right side of the center extending piece 25.

As shown in FIG. 4, as a result of the locking parts 50 engaging with the center extending piece 25 from above at a position located rightward relative to the second center curved portion 48, the center extending piece 25 is held on the placement part 34 in a state in which the first center curved portion 47 and the second center curved portion 48 are prevented from springing upward so as to deform back to their original shapes.

The interval between the lower surface of each locking part 50 and the upper surface of the placement part 34 is formed to be larger than the thickness of the center extending piece 25. Accordingly, the center extending piece 25 is flexed in the space between the locking part 50 and the placement part 34. In the present embodiment, a left end portion of each of the locking parts 50 and the center extending piece 25 are in contact with each other, and a right end portion of each of the locking parts 50 and the center extending piece 25 are separated from each other.

As shown in FIG. 4, a distal end portion of the center extension piece 25 is disposed below the thermistor accommodating part 42. The thermistor unit 29 is disposed on the first surface 21 side of the center extension piece 25. The structures of the thermistor accommodating part 42 and the thermistor unit 29 are the same as the structures described in the side extension piece 24 above, and therefore redundant descriptions thereof have been omitted.

### Operations and Effects of the Present Embodiment

Next, operations and effects of the present embodiment will be described. The present embodiment is a wiring module 12 to be attached to a plurality of power storage devices 11 arranged in the front-rear direction, the wiring module 12 including: an insulating protector 14; and a flexible printed wiring board 15 disposed in the protector 14, wherein the protector 14 has a shape extending in the front-rear direction, the flexible printed wiring board 15 includes a main body part 23 extending in the front-rear direction and disposed in the protector 14, and a side extension piece 24 and a center extension piece 25 that extend from the main body part 23, the side extension piece 24 has a first side curved portion 43 and a second side curved portion 46 that are curved, and the side extension piece 24 is inverted by the first side curved portion 43 and the second side curved portion 46, the center extension piece 25 has a first center curved portion 47 and a second center curved portion 48 that are curved, and the center extension piece 25 is inverted by the first center curved portion 47 and the second center curved portion 48, and the protector 14 includes locking parts 45A and 45B that lock to side extension piece 24 and locking parts 50 that lock to the center extension piece 25, from a direction to prevent the first side curved portion 43, the second side curved portion 46, the first center curved portion 47, and the second center curved portion 48 from deforming back to their original shapes.

When the direction in which the side extension piece 24 and the center extension piece 25 are routed is changed by inverting the side extension piece 24 and the center extension piece 25, distortion occurs in the side extension piece 24 and the center extension piece 25. According to the present disclosure, this distortion can be dispersed by the first side curved portion 43, the second side curved portion 46, the first center curved portion 47, and the second center curved portion 48. Accordingly, it is possible to prevent an excessively large force from being applied to the flexible printed wiring board 15.

Furthermore, as a result of the locking parts 45A and 45B locking to the side extension piece 24, and the locking parts 50 locking to the center extension piece 25, it is possible to prevent the first side curved portion 43, the second side curved portion 46, the first center curved portion 47, and the second center curved portion 48 of the side extension piece 24 and the center extension piece 25 from deforming back to their original shapes. Accordingly, it is possible to keep the curved states of the first side curved portion 43, the second side curved portion 46, the first center curved portion 47, and the second center curved portion 48.

According to the present embodiment, the protector 14 includes a placement part 34 on which the main body part 23 is disposed, the locking parts 45A and 45B protrude, from distal ends of the column parts 44A and 44B protruding from the placement part 34, in a direction intersecting the direction in which the column parts 44A and 44B extend, and the locking parts 45A and 45B lock to the side extension piece 24 from a side opposite to the placement part 34. The locking parts 50 protrude, from distal ends of the column parts 49 protruding from the placement part 34, in a direction intersecting the direction in which the column parts 49 extend, and the locking parts 50 lock to the center extension piece 25 from a side opposite to the placement part 34.

With a simple operation of disposing the side extension piece 24 and the center extension piece 25 between the placement part 34 and the locking parts 45A and 45B, it is possible to hold the side extension piece 24 and the center extension piece 25 in the protector 14, while keeping the curved states of the first side curved portion 43, the second side curved portion 46, the first center curved portion 47, and the second center curved portion 48 of the side extension piece 24 and the center extension piece 25. This can improve the manufacturing efficiency of the wiring module 12.

According to the present embodiment, the interval between the locking parts 45A and 45B and the placement part 34 is set to be larger than the thickness of the side extension piece 24, and the interval between the locking parts 50 and the placement part 34 is set to be larger than the thickness of the center extension piece 25.

Since the interval between the locking parts 45A and 45B and the placement part 34 is larger than the thickness of the side extension piece 24, and the interval between the locking parts 50 and the placement part 34 is larger than the thickness of the center extension piece 25, the operation of locking the side extension piece 24 to the locking parts 45A and 45B, and locking the center extension piece 25 to be locked to the locking parts 50 is made easier.

According to the present embodiment, the side extension piece 24 and the main body part 23 are coupled to each other via a first proximal end portion 30, the center extension piece 25 and the main body part 23 are coupled to each other via a second proximal end portion 32, and the main body part 23 has a first cut-out portion 31 extending rearward from the first proximal end portion 30 and from which the side extension piece 24 is cut out, and a second cut-out portion 33 extending forward from the second proximal end portion 32 and from which the center extension piece 25 is cut out.

The side extension piece 24 and the center extension piece 25 can be formed by cutting out a side extension piece 24 and a center extension piece 25 from the main body part 23 along the front-rear direction in which the power storage devices 11 are arranged, and curving the side extension piece 24 and the center extension piece 25. As a result, it is possible to increase the yield of the flexible printed wiring board 15 as compared with the case where the side extension piece 24 and the center extension piece 25 are formed so as to extend laterally from the side edge of the main body part 23.

According to the present embodiment, the side extension piece 24 extends forward from a front end edge of the main body part 23, and extends leftward relative to a left edge of the main body part 23, and the center extension piece 25 extends rightward relative to a right edge of the main body part 23. Thus, with the technique according to the present disclosure, the side extension piece 24 and the center extension piece 25 can be routed in a region located outward relative to the contour of the main body part 23.

According to the present embodiment, a thermistor unit 29 that detects the state of at least one of the plurality of power storage devices 11 is connected to a distal end portion of each of the side extension piece 24 and the center extension piece 25, and the distal end portion of each of the side extension piece 24 and the center extension piece 25 is pressed against the at least one of the plurality of power storage devices 11.

The temperature of the power storage device 11 can be detected by the thermistor unit 29 connected to the distal end portion of each of the side extension piece 24 and the center extension piece 25.

According to the present embodiment, the flexible printed wiring board 15 has a first surface 21 on which a conductive path 20 is formed, and a second surface 22 on which the conductive path 20 is not formed, and the thermistor unit 29 is connected to the conductive path 20 on the first surface 21 of each of the side extension piece 24 and the center extension piece 25.

It is possible to reduce the manufacturing cost of the flexible printed wiring board 15 as compared with the case where the conductive path 20 is formed on both surfaces of the flexible printed wiring board 15.

According to the present embodiment, the second surface 22 of the distal end portion of each of the side extension piece 24 and the center extension piece 25 is pressed against the power storage device 11.

Since the second surface 22, on which the conductive path 20 is not formed, of the flexible printed wiring board 15 is pressed against the power storage devices 11, it is possible to prevent an excessive force from being applied to the conductive path 20. This can suppress the occurrence of a problem in the conductive path 20.

The wiring module 12 according to the present embodiment is a vehicle wiring module 12 that is to be used mounted in a vehicle 1. Even when the vibrations from the vehicle 1 are conducted to the wiring module 12, the first side curved portion 43, the second side curved portion 46, the first center curved portion 47, and the second center curved portion 48 absorb the vibrations, thus preventing a force from being applied to the sheet 19 or the conductive path 20 that is a component of the flexible printed wiring board 15. As a result, it is possible to suppress a problem such as damage to the sheet 19 or the conductive path 20. Thus, the wiring module 12 according to the present embodiment can be suitably used for the vehicle 1 in which vibrations occur when the vehicle 1 is traveling.

### Embodiment 2

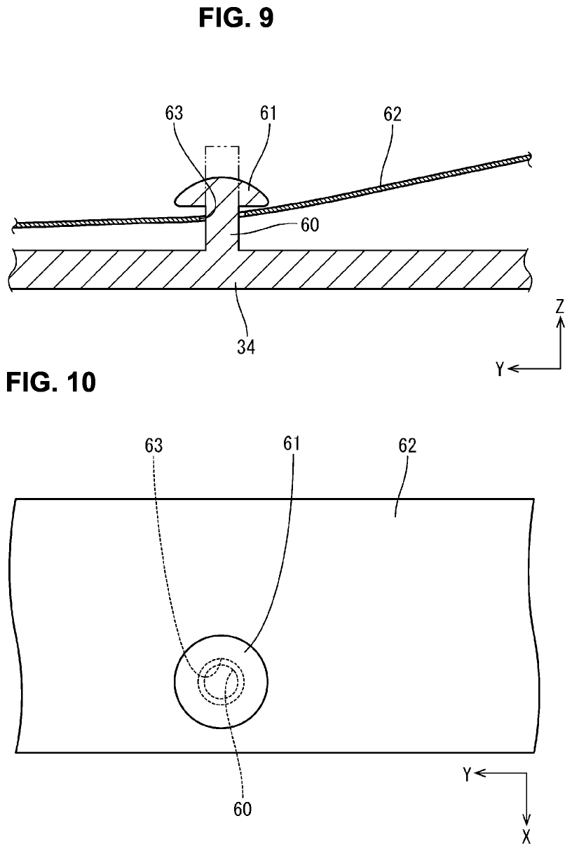

Next, Embodiment 2 of the present disclosure will be described with reference to FIGS. 9 and 10. In the present embodiment, a column part 60 having a circular columnar shape protrudes from the placement part 34, and a locking part 61 is formed at a distal end of the column part 60. The diameter of the locking part 61 is enlarged so as to be larger than the outer diameter of the column part 60.

An extension piece 62 according to the present embodiment has, at a position corresponding to the column part 60, an insertion hole 63 extending through the extension piece 62 and through which the column part 60 is passed. The inner shape of the insertion hole 63 is circular. The inner diameter of the insertion hole 63 is formed to be the same as the outer diameter of the column part 60. The inner diameter of the insertion hole 63 is smaller than the outer diameter of the locking part 61. Accordingly, the locking part 61 locks to a hole edge portion of the insertion hole 63 from above.

The rest of the configuration is substantially the same as that of Embodiment 1, and therefore the same members are denoted by the same reference numerals, and redundant descriptions thereof have been omitted.

For example, the locking part 61 is formed in the following manner. The column part 60 is passed through the insertion hole 63 formed in the extension piece 62. A distal end (the portion indicated by the dashed double-dotted line in FIG. 8) of the thus inserted column part 60 is heated and also pressed using a jig, which is not shown. Consequently, the distal end of the column part 60 is crushed so as to be enlarged in diameter. In this manner, the locking part 61 whose diameter has been enlarged to be larger than the outer diameter of the column part 60 is formed.

Since the locking part 61 according to the present embodiment has an outer diameter larger than the inner diameter of the insertion hole 63, the extension piece 62 can be held on the placement part 34 while being prevented from being dislodged.

### Embodiment 3

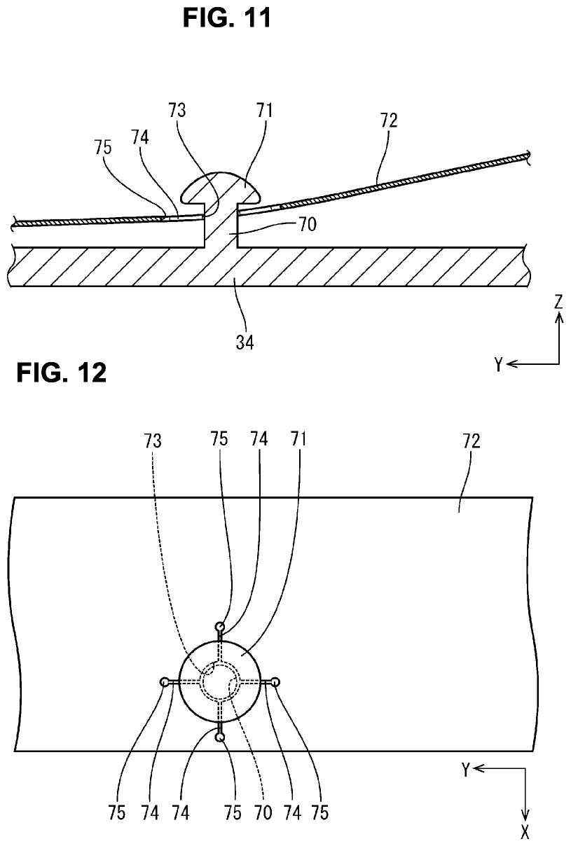

Next, Embodiment 3 of the present disclosure will be described with reference to FIGS. 11 and 12. In the present embodiment, a column part 70 having a circular columnar shape protrudes from the placement part 34, and a locking part 71 is formed at a distal end of the column part 70. The diameter of the locking part 71 is enlarged so as to be larger than the outer diameter of the column part 70.

An extension piece 72 according to the present embodiment has, at a position corresponding to the column part 70, an insertion hole 73 extending through the extension piece 72 and through which the column part 70 is passed. The inner shape of the insertion hole 73 is circular. The inner diameter of the insertion hole 73 is formed to be the same as the outer diameter of the column part 70.

The extension piece 72 has a plurality of (four in the present embodiment) slits 74 extending outward in the radial direction of the insertion hole 73 from a hole edge of the insertion hole 73. The four slits 74 extend forward, rearward, rightward, and leftward, respectively. A round hole 75 extending through the extension piece 72 is formed at an end portion of each of the slits 74. The round hole 75 makes it possible to prevent the extension piece 72 from cleaving the end portion of the slit 74.

The inner diameter of the insertion hole 73 is smaller than the outer diameter of the locking part 71. Accordingly, the locking part 71 locks to a hole edge portion of the insertion hole 73 from above.

The rest of the configuration is substantially the same as that of Embodiment 1, and therefore the same members are denoted by the same reference numerals, and redundant descriptions thereof have been omitted.

The column part 70, and the locking part 71 whose diameter is enlarged at the distal end of the column part 70 are formed on the placement part 34. The locking part 71 may be formed in one piece with the column part 70 when the placement part 34 is injection molded, or may be formed by heating and pressurizing the distal end of the column part 70 after the column part 70 has been formed.

The locking part 71 is passed through the insertion hole 73 formed in the extension piece 72. At this time, the hole edge portions of the insertion hole 73 that have been divided by the slits 74 are lifted as a result of coming into contact with the locking part 71. After the divided hole edge portions of the insertion hole 73 have moved over the locking part 71, the lifted hole edge portions of the insertion hole 73 deform back to their original shapes, thus bringing about a state in which the column part 70 is passed through the insertion hole 73. Since the locking part 71 has an outer diameter larger than the inner diameter of the insertion hole 73, the extension piece 72 can be held in the placement part 34 while being prevented from being dislodged.

### Embodiment 4

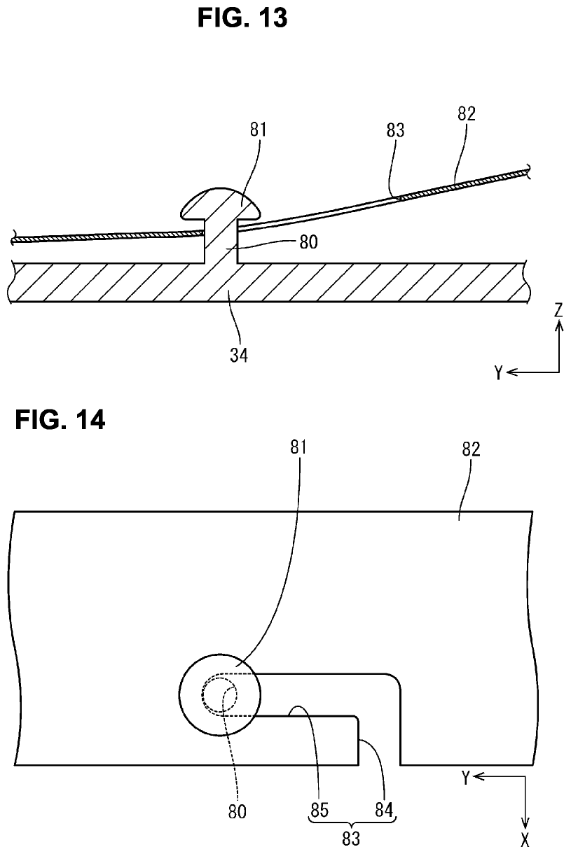

Next, Embodiment 4 of the present disclosure will be described with reference to FIGS. 13 and 14. In the present embodiment, a column part 80 having a circular columnar shape protrudes from the placement part 34, and a locking part 81 is formed at a distal end of the column part 80. The diameter of the locking part 81 is enlarged so as to be larger than the outer diameter of the column part 80.

An opening 83 that is open leftward is formed in the extension piece 82 according to the present embodiment at a position located toward a left edge thereof. The opening 83 is formed in a substantially L-shape as viewed from above. A portion of the opening 83 that is open leftward and extends in a direction (the rightward direction in the present embodiment) away from a side edge of the extension piece 82 serves as an entry part 84. A portion of the opening 83 that is in communication with the entry part 84 and extends in a direction (the forward direction in the present embodiment) intersecting the direction in which the entry part 84 extend serves as an accommodating part 85. In the present embodiment, the direction in which the entry part 84 extends and the direction in which the accommodating part 85 extends are orthogonal to each other.

The column part 80 is configured to enter the entry part 84 that is open at a side edge of the extension piece 82. The distance across the entry part 84 in the front-rear direction is formed to be the same as, or slightly larger than the outer diameter of the column part 80.

The distance across the accommodating part 85 in the left-right direction is formed to be the same as, or slightly larger than the outer diameter of the column part 80, and is also formed to be smaller than the outer diameter of the locking part 81. Accordingly, the locking part 81 accommodated in the accommodating part 85 locks to a hole edge portion of the accommodating part 85 from above.

The rest of the configuration is substantially the same as that of Embodiment 1, and therefore the same members are denoted by the same reference numerals, and redundant descriptions thereof have been omitted.

The column part 80 is inserted into the entry part 84 of the opening 83 from the left side. After the column part 80 has moved to a right end portion of the entry part 84, the column part 80 is moved forward to a front end portion of the accommodating part 85. In a state in which the column part 80 has moved to the front end portion of the accommodating part 85, the locking part 81 locks to the hole edge portion of the accommodating part 85 from above. This allows the extension piece 82 to be held in the placement part 34 while being prevented from being dislodged.

### Other Embodiments

(1) In Embodiment 1, the conductive path 20 is formed on only one surface of the flexible printed wiring board 15. However, the present disclosure is not limited thereto, and the conductive path 20 may be formed on both surfaces of the flexible printed wiring board 15.

(2) In Embodiment 1, the thermistor unit 29 is connected to the distal end portion of each of the side extension piece 24 and the center extension piece 25. However, the present disclosure is not limited thereto. It is also possible to adopt a configuration in which the voltage of the power storage devices 11 is detected by connecting a voltage detection terminal or a bus bar to the distal end portion of each of the extension pieces.

(3) The power storage device 11 may be a secondary battery such as a lithium ion secondary battery and a nickel hydrogen secondary battery, or may be a capacitor.

(4) It is also possible to adopt a configuration in which the flexible printed wiring board 15 is disposed along a side wall of the protector 14, and the locking part is formed on the side wall.

(5) In Embodiments 1 to 4, the locking part is formed at a distal end of the column part. However, the present disclosure is not limited thereto. The locking part may be an inner wall of a groove part formed in the protector. The inner wall of the groove part may be locked to the extension piece inserted in the groove part, whereby the curved portion is kept in the curved state.

(6) In Embodiment 1, the flexible printed wiring board 15 includes the side extension piece 24 and the center extension piece 25. However, the present disclosure is not limited thereto, and it is also possible to adopt a configuration in which the flexible printed wiring board 15 includes one extension piece, or three or more extension pieces.

(7) In Embodiment 1, sets of power storage devices 11, each set including three power storage devices 11 connected in parallel, are connected in series by the small bus bars 16A and the large bus bars 16B. However, the present disclosure is not limited thereto, and it is also possible to adopt a configuration in which the power storage devices 11 are connected in series, and there is no limitation on the connection structure of the power storage devices 11.

(8) It is also possible to adopt a configuration in which one curved portion, or three or more curved portions may be formed on one extension piece.

### LIST OF REFERENCE NUMERALS

1 Vehicle

2 Power storage pack

3 PCU

4 Wire harness

10 Power storage module

11 Power storage device

12 Wiring module

13 Electrode terminal

14 Protector

15 Flexible printed wiring board

16 Bus bar

16A Small bus bar

16B Large bus bar

17 Terminal connection part

18 Coupling part

19 Sheet

20 Conductive path

21 First surface

22 Second surface

23 Main body part

24 Side extension piece (example of extension piece)

25 Center extension piece (example of extension piece)

26 Coupling piece

27 Through hole

29 Thermistor unit

30 First proximal end portion (example of proximal end portion)

31 First cut-out portion (example of cut-out portion)

32 Second proximal end portion (example of proximal end portion)

33 Second cut-out portion (example of cut-out portion)

34 Placement part

35 Bus bar accommodating part

35A Small bus bar accommodating part

35B Large bus bar accommodating part

36 Engagement pin

37 Elongated hole

38A, 38B Hinge part

39A, 39B Frame part

40A, 40B Locking pawl

41A, 41B Coupling piece insertion part

42 Thermistor accommodating part

43 First side curved portion (example of curved portion)

44A, 44B, 49, 60, 70, 80 Column part

45A, 45B, 50, 61, 71, 81 Locking part

46 Second side curved portion (example of curved portion)

47 First center curved portion (example of curved portion)

48 Second center curved portion (example of curved portion)

62, 72, 82 Extension piece

63, 73 Insertion hole

74 Slit

75 Round hole

83 Opening

84 Entry part

85 Accommodating part

1. A wiring module to be attached to a plurality of power storage devices arranged in an arrangement direction, the wiring module comprising:
an insulating protector; and
a flexible printed wiring board disposed in the protector,
wherein the protector has a shape extending in the arrangement direction,
the flexible printed wiring board includes a main body part extending in the arrangement direction and disposed in the protector, and an extension piece extending from the main body part,
the extension piece has a curved portion that is curved, and the extension piece is inverted by the curved portion, and
the protector includes a locking part that locks to the extension piece from a direction to prevent the curved portion from deforming back to an original shape thereof.

2. The wiring module according to claim 1,
wherein the protector includes a placement part on which the main body part is disposed,
the locking part protrudes, from a distal end of a column part protruding from the placement part, in a direction intersecting a direction in which the column part extends, and
the locking part locks to the extension piece from a side opposite to the placement part.

3. The wiring module according to claim 2,
wherein an interval between the locking part and the placement part is set to be larger than the thickness of the extension piece.

4. The wiring module according to claim 1,
wherein the extension piece and the main body part are coupled to each other via a proximal end portion, and
the main body part includes a cut-out portion extending from the proximal end portion in the arrangement direction, and from which the extension piece is cut out.

5. The wiring module according to claim 1,
wherein the extension piece extends outward relative to a contour of the main body part.

6. The wiring module according to claim 1,
wherein a detection unit that detects the state of at least one of the plurality of power storage devices is connected to a distal end portion of the extension piece, and the distal end portion of the extension piece is pressed against the at least one of the plurality of power storage devices.

7. The wiring module according to claim 6,
wherein the flexible printed wiring board has a first surface on which a conductive path is formed, and a second surface on which the conductive path is not formed, and
the detection unit is connected to the conductive path on the first surface of the extension piece.

8. The wiring module according to claim 7,
wherein the second surface of the distal end portion of the extension piece is pressed against the power storage device.

9. The wiring module according to claim 1,
wherein the wiring module is a vehicle wiring module that is to be used mounted in a vehicle.
